(19) United States
(12) Patent Application Publication
(10) Pub. No.: US 2004/0230973 A1
(43) Pub. Date: Nov. 18, 2004

(54) Mechanism to provide adminstrative control in a multi-process application server

(75) Inventors: Roger L. Cundiff JR., Austin, TX (US); Harvey T. McGee, Hyde Park, NY (US); Christopher P. Vignola, Port Jervis, NY (US); Leigh A. Williamson, Austin, TX (US)

Correspondence Address: Philmore H. Colburn II, Cantor Colburn LLP, 55 Griffin Road South, Bloomfield, CT, 06002, US

(73) Assignee: INTERNATIONAL BUSINESS MACHINES CORPORATION, Armonk, NY

(21) Appl. No.: 10/427,527

(22) Filed: Apr. 30, 2003

(51) Int. Cl. G06F 9/455

(52) U.S. Cl. 718/1

(57) ABSTRACT

A system, method and software product for providing an implementation for “management beans” or MBeans in a multiple Java Virtual Machine (JVM) server is disclosed. By providing a single MBean interface so that a client or an element external to the server executes a single request and/or receives a single notification, no matter how many servant JVMs exist, to the external element, the multiple JVM system appears to act like a single JVM system. These new techniques for providing management across several JVM servers depend upon one server being designated as a control JVM and the remaining JVM servers being designated as servant JVMs, under the control of the control JVM. The control JVM distributes work requests across the servant JVMs in an implementation specific way. Such systems are preferably implemented using an MBean proxy which receives requests from external elements, delegates the requests to a particular servant JVM in which the processing is under the control of an MBean that is local to the control JVM, then receives notifications from the servant JVMs and aggregates the notifications from the servant MBeans into an aggregate notification which it then sends out from the server.

### BACKGROUND OF THE INVENTION

1. Field of the Invention

The present invention relates in general to the field of distributed object-oriented computing on server environments and more particularly to a Java Management Extension (JMX) implementation in a multi-process (MP) server environment which operates in a manner that hides the number of processes internally operating in the MP environment so that networked elements external to the MP server see an image of a singular server, no matter how many servant Java Virtual Machines (JVMs) may exist internally.

2. Discussion

J2EE, a popular distributed, service-based enterprise platform, is comprised of many different kinds of resources that are dynamically created, distributed, moved across nodes, redeployed and destroyed. J2EE provides both client-side and server-side functionality for distributed, multitiered applications. JMX is an emerging J2EE Standard for J2EE Server Management. JMX defines an architecture for software and network management in the Java programming language, providing a standardized approach to starting, managing, monitoring, and stopping different software components or applications. JMX provides the tools for building distributed, Web-based, modular and dynamic solutions for managing and monitoring devices, applications and service-driven networks.

Most JMX implementations utilize a single JVM. The WebSphere® application server package developed by and commercially available from IBM utilizes multiple JVMs in its JMX implementation. In order for applications to run on JMX implementations that utilize either single process JVMs or multi-process JVMs, it is necessary for the multi-process JVM to present itself to the applications as if it were a single-process JVM. This allows classes of computers that have single-process JVM implementations to be grouped into networks with classes of computers that have multi-process JVM implementations.

In J2EE there is a specification for so-called “management beans” or MBeans for short. MBeans are JavaBeans written and used for the management of component resources in environments like application servers and they are run under a JMX implementation. MBeans are used as the management interface to the application server system components. MBeans are registered to an agent that is able to manipulate the registered management components, and acts as the registry for the MBeans. Thus, in the JMX architecture, clients are decoupled from the actual managed resources represented by the MBeans. All communications between the client and the MBeans are carried out through the agent level. The agent acts as a communication conduit between the management applications and the MBeans which represent the resources to be managed. The core component of the agent is the MBean Server. It is the MBean server acts as a registry for the MBeans.

The MBean specification contained in the JMX standard describes only local MBean registration and invocation. The MBean server itself is a local object to the JVM and does not offer means to remotely connect to it. The specification assumes a single application server is a single JVM execution environment and thus addresses the issue of MBean access, dispatch and control in the context of a single process JVM server only. It does not address the issue of MBean access, dispatch, and control in a multi-process JVM server such as the WebSphere server software system.

The WebSphere z/OS server software system is an Internet software platform developed by and commercially available from IBM. Among other things, it allows the running of multiple JVMs in a single machine or on a multi-processor cluster system and is often used as a high performance, distributed object application server. The WebSphere” application server software package, although JMX-compliant, does not currently address the issue of MBean access, dispatch, and control in a multiple JVM server.

Tasks such as providing a single MBean interface to a multi-JVM server while at the same time taking administrative action across each of the JVMs is presently unaddressed by either the J2EE specification or any JMX implementation. Whether MBean notifications from these same multiple JVMs should be somehow reduced or even collapsed into a single notification that represents the notification from the “server” is also unaddressed.

The WebSphere z/OS server is a multiple process (i.e., multiple address space) multiple JVM server which runs one process per JVM. These multiple processes/JVMs are coordinated and managed to present an image as a singular server to the network. The present invention is based in part upon the recognition that it would be useful to present the administration and management of a WebSphere z/OS server in a manner such that the server appears as a single computer element rather than a jumble of processes, each one requiring separate administrative action and control to the external world or clients. A client is a processing device which utilizes a service from a server and may request the service. By presenting itself as a single-process server to the external world or clients, JMX operations on a managed component will exhibit uniform observed behavior whether the server architecture in which the managed component executes is a single process, single JVM server, or whether the server is a multi-process server with multiple JVMs, one per process. This is in keeping with the portable nature of programs written in Java and allows programs written for a server that is a single-JVM to also run on multi-process servers or multi-process JVMs. It also allows computers that have implemented JMX in a single-JVM environment to be integrated into systems with computers that have implemented JMX in a multi-process JVM environment.

FIGS. 1 through 4 describe the various known process that act on MBeans within an existing computer architecture that consists of a J2EE implementation on a single-process JVM server. Within the J2EE environment, a managed component is a J2EE component (application or server) that registers an MBean interface with a local JMX service. FIG. 1 describes the process 30, known to those skilled in the art, of activating an MBean in a single process server. MBean activation occurs when a managed component at block 32 calls, through path 34, the local JMX interface 35, called “Admin Service” as shown in oval 36.” The Admin Service 35 reads an MBean Descriptor (XML) 38, from the appropriate repository 40 over a suitable communications path 42. As is well-known, the MBean descriptor 38 is defined by the JMX architecture and it describes the MBean's interface. The Admin Service 35 then activates the MBean 44 through path 46 from the local MBean server 45 shown in block 48. MBean server 45 is a core component of the JMX agent layer. It is responsible for decoupling the management applications from the managed resources. The MBean server acts as a registry for the MBeans. The MBean server 45 instantiates the MBean, as shown by path 46, such that the MBean is ready to be used once it has been instantiated by the Admin Service.

FIG. 2 describes the process 50, known to those skilled in the art, of a single-process invocation or an operation on a managed component. Once the MBean is instantiated, an MBean operation may be invoked by any J2EE application component 52. The application component 52 invokes the Admin Service 35 shown in oval 55, as shown bypath 56. The Admin Service forwards the call, as shown by path 58, to the MBean server 45. Server 45 locates the MBean 44 and, assuming it has been instantiated, invokes the operation on the MBean 44 as shown by path 60 which in turn invokes the actual operation on the managed component 64. Thus, the communications between the management applications and the MBeans go through the Admin Service 35 and managed components are accessed through the JMX MBean server 45.

FIG. 3 describes the process, known to those skilled in the art, of registering a listener in a single-process server. An application component 72 registers as an event listener with the local Admin Service 35, as shown by oval 75. The Admin Service 35, in turn, registers the listener with the local MBean server, as shown in block 78.

FIG. 4 describes the notification process 80 in a single process server, a process with which those skilled in the art will be familiar. A managed component 82 raises an event by sending a notification along path 83 through the Admin Service 35, as shown in oval 85. The Admin Service 35 passes the notification along path 86 to the MBean server 45 in block 88. The MBean server 45 delivers the notification along path 87 to the application component, as shown by path 87.

FIG. 5, by way of more background, describes atypical multi-process J2EE application (app) server 100, also referred to as a multi-process (MP) server. In a multi-process JVM server, one JVM will be designated as the “control” JVM, see block 101. The remaining processes will be designated as “servant” JVMs, see blocks 102 and 104, which are servant processes 1 and N, with more processes not shown, but practical and suggested by ellipses 103. The control process contains control server components, as shown in block 108. The control process or control JVM is typically used to receive requests 106 to perform work. The Control process then uses some type of workload distribution mechanism 110 to distribute the work across paths 112 and 114 to the multiple servant JVMs or processes in an implementation specific way, as shown in FIG. 5. Each servant process contains the necessary J2EE server components (122 and 124) necessary to carry out the request and pass it on to the application component (116 and 118) that is the target of the request, as shown by paths 126 and 128. There are two MBean models that can exist in the multi-process server. The first is the control process MBeans that are activated only in the control process. The second is the servant process MBeans that are activated only in the servant process.

FIG. 6 depicts a control process 130 MBean activation in a multi-process JVM. This activation process proceeds in the same manner as activation of an MBean in a single JVM environment. A managed component 132 calls the local JMX interface 135, labeled Admin Service C, and shown in oval 136. The Amin Service C 135 reads via path 142 an MBean descriptor 138 from a repository 140. The descriptor is defined by the JMX architecture and defines the MBean's interface. The Admin Service C 135 then activates the MBean 144 with the local MBean server 145 shown in block 148. The MBean server instantiates the MBean which is now ready to use, as indicated by path 146.

The J2EE standard and current JMX and WebSphere specifications do not address how the administration and management controls should present themselves to clients in the external world in a multi-process server environment.

### SUMMARY OF THE INVENTION

In light of the limitations associated with foregoing distributed computing issues, the present invention provides preferred systems and methods for administrative and management controls in a multi-process server environment to present a unified and well-ordered appearance to the external world so that programs written for single-process JVM servers can be portable to multi-process JVM servers. They also allow computers that have implemented JMX in a single-JVM environment to be integrated into systems with computers that have implemented JMX in a multi-process JVM environment. There is provided, in accordance with a first exemplary embodiment of the present invention, a novel software system within a distributed computing environment that includes a multi-JVM server in which one JVM is designated as the control JVM and the remainder are “servant” JVMs. In this embodiment, the control JVM owns the network attachments (ports, etc.) for the server. The control JVM is operable to distribute the work requests across the servant JVMs in an implementation specific way. The servant JVMs are arranged similarly to one another and thus are considered to be like-configured. MBeans may be registered in any of the servant JVMs. MBean management in the foregoing environment is accomplished through the use of an MBean proxy arrangement in the control JVM. This MBean proxy arrangement is responsible for coordinating inbound MBean requests and outbound notifications to and from the MBeans that exist across the servant JVMs.

### BRIEF DESCRIPTION OF THE DRAWINGS

The drawings form an integral part of the description of the preferred embodiments and are to be read in conjunction therewith. Like reference numerals designate the same or similar components or features in the various Figures, where:

FIG. 1 illustrates a known single process activation.

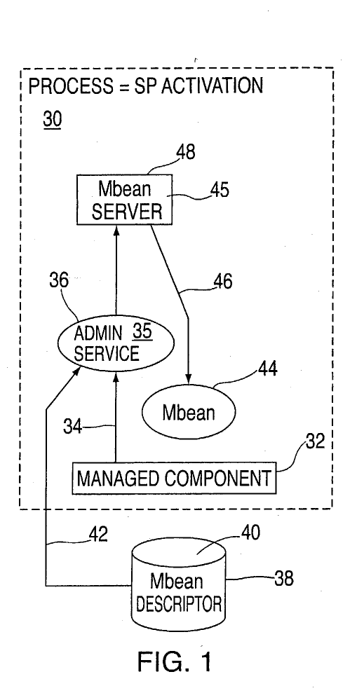

FIG. 2 illustrates a known single process invocation.

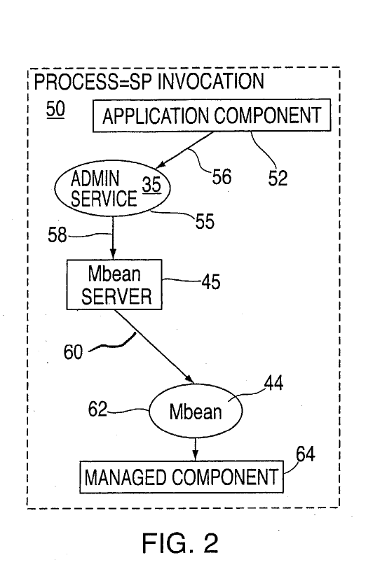

FIG. 3 illustrates a known listener registration.

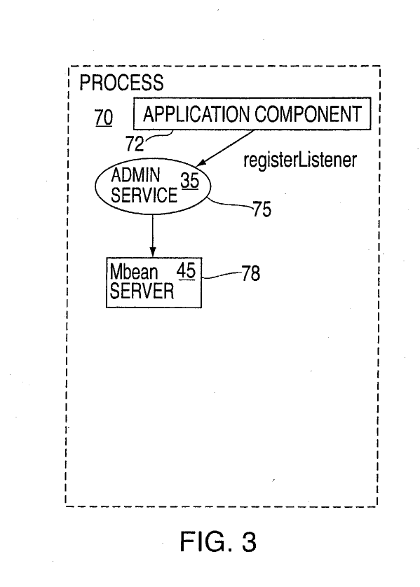

FIG. 4 illustrates a known single process notification by a managed component.

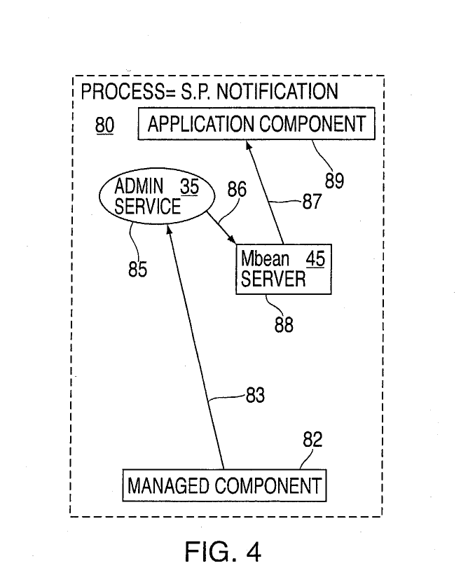

FIG. 5 illustrates a known multi-process J2EE application server environment.

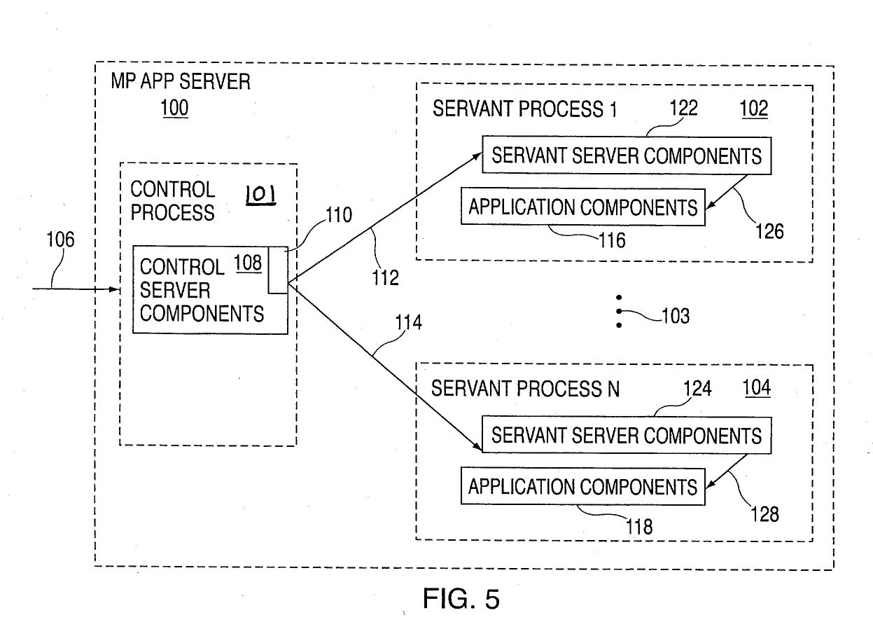

FIG. 6 illustrates a known control process MBean activation.

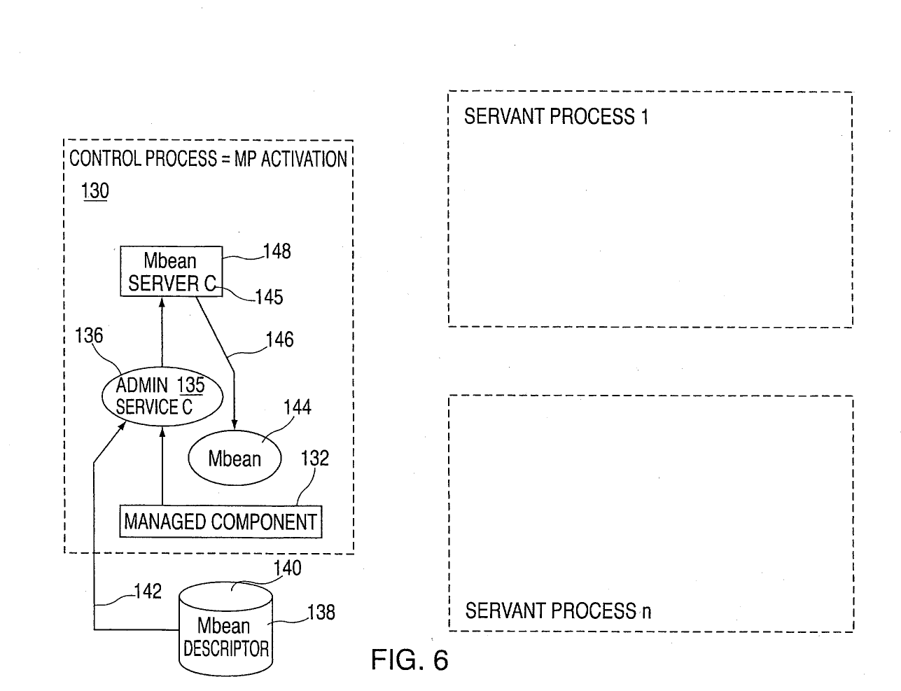

FIGS. 7 through 12 each illustrates portions of the present invention where FIG. 7 is a block diagram which describes control invocation from an application component in a servant process onto a Control Process MBean.

FIG. 8 is a block diagram which describes the process of registering a listener for the events raised by a Control Process MBean.

FIG. 9 is a block diagram which describes the process of sending a notification from a Control MBean to all registered listeners.

FIG. 10 is a block diagram which depicts Servant Process MBean activation.

FIG. 11 is a block diagram which depicts Servant Invocation.

FIG. 12 is a block diagram which depicts Servant Notification.

### DESCRIPTION OF THE EXEMPLARY EMBODIMENTS

The present invention is illustrated and described herein in connection with preferred embodiments, with the understanding that the present disclosure is to be considered as an exemplification of the principles of the invention and the associated functional specifications required for its implementation. However, it should be appreciated that the systems and methods of the present invention may be implemented in still different configurations and forms, and that other variations within the scope of the present invention are possible based on the teachings herein.

Prior to discussing the embodiments of the present invention, it is useful to look more closely at some of the known characteristics of an existing multi-process computer system having a large dynamic multiple address space. One such class of systems if IBM's z900 series computer systems which may be run under IBM's z/OS operating system. Such systems are often used for large web server applications, in which case the well-known WebSphere application software package from IBM is normally also used. WebSphere provides a J2EE-complaint application deployment environment for applications implemented as Java server-side code. The WebSphere z/OS server is a multiple process (address space) multiple-JVM server, implemented as one process per JVM. This system has implemented MBean services (managed bean resources) under the multi-server region server environment of the z/OS operating system infrastructure. In this system, a control process MBean activation proceeds in the same manner as is known for single-JVM environments.

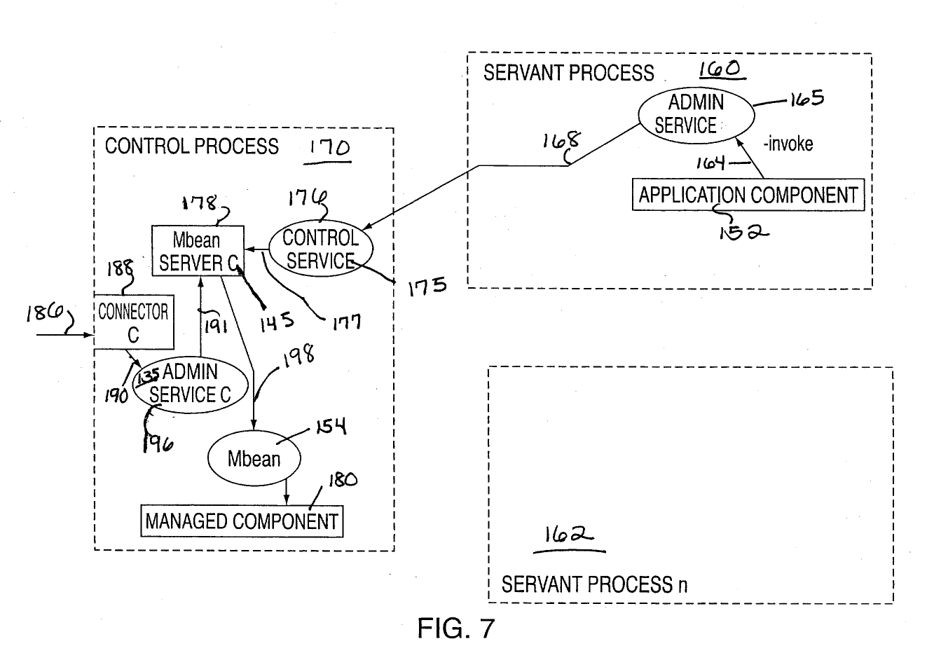

FIG. 7 depicts an MBean invocation from an application component 152 in a servant process 160 onto a Control Process MBean 154. The application component 152 requests the MBean invocation 164 through the local Admin Service 165. The local Admin Service 165 redirects the invocation request 168 to the Control Service interface 175 in the Control Process 170 as shown at oval 176. The Control Service 175 is a remote object implementation (e.g. RMI/IIOP) that provides remote access to the Control Process' JMX facility from the Servant Process, as shown indicated. The Control Process 170 then passes the request via path 177 to the local Control Process MBean server 145, as shown in block 178, which in turn invokes the MBean 154 and finally the managed component 180. Similarly, a remote JMX request 186 may arrive from outside the server through a JMX connector 188. The JMX Architecture standards discuss the use of JMX connectors to provide for remote access but has not yet specified the architecture of the connector. However, it is clear that such a connector, which is a natural extension of the JMX architecture, can be created using available art such as HTTP, IIOP, etc. JMX connectors are used for remote clients to attach to the server for the purpose of invoking JMX functions in that server. This is in contrast to Control Service interface, which is used strictly for access to the Control Process JMX facilities from the servant processes. A remote request 186 via JMX connector 188 arrives in the server and is routed on path 190 to the Control Process Admin Service 135 shown in oval 196. The Admin Service invokes the local MBean server 145 which in turns drives the MBean 154, as shown indicated by path 198 and managed component 180.

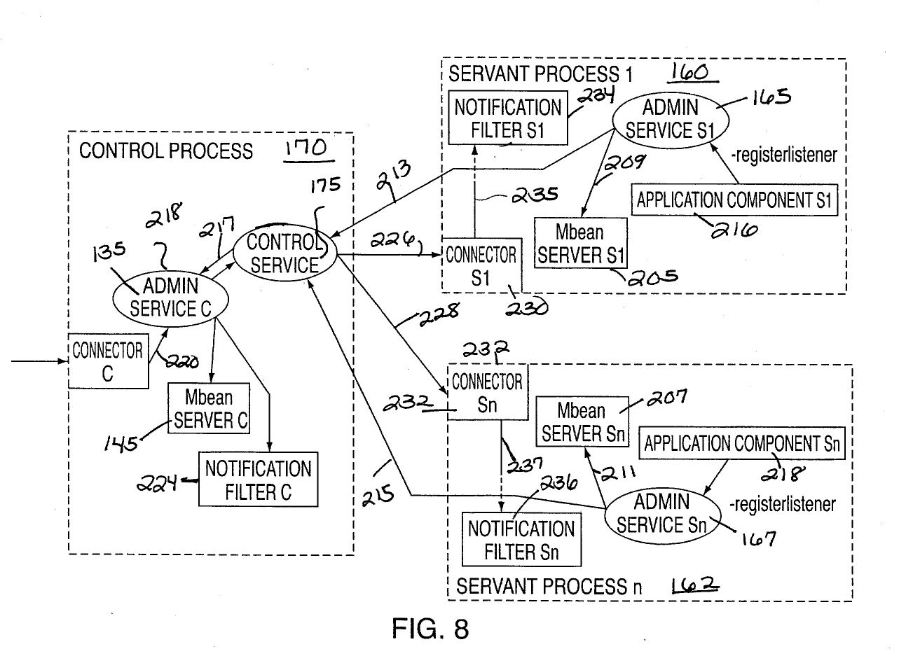

FIG. 8 depicts registering a listener for events raised by a Control Process MBean. The Application Components, 216 and 218, in Servant Process 160 and the Nth Servant Process 162 invoke their local Admin Services, 165 and 167, respectively, to register themselves as listeners for events raised by the appropriate Control Process MBean. The Servant Processes' Admin Services 165 and 167 invoke their local MBean Servers 205 and 207 to locally register the listeners via paths 213 and 215 and at the same time invoke the Control Service 175 to initiate listener registration via paths 209 and 211 in the Control Process 170. Once in the Control Process, the Control Service 175 passes the listener registration request via path 217 to the Control Process Admin Service 135 in oval 218.

When a remote listener comes in through the Control Process JMX connector 188, Connector 188 passes the registration request along path 220 to the Control Process Admin Service 135. After this point, both the remote listener registration and the servant process-originated registration requests follow the same path. The Admin Service 135, in turn, registers the listener with both the local MBean server 145 and with a Notification Filter 224, a component which is used to track which event types have current registrations. The Admin Service 135 must then push a Notification Filter update down to the servant processes. This call down to the servant processes arrives over paths 226 and 228 through JMX connectors 230 and 232 in servant processes 160 and 162, respectively. The connectors then pass the calls along paths 235 and 237 to their respective Notification Filters 234 and 236. The Notification Filters are used to track which event types have current registrations.

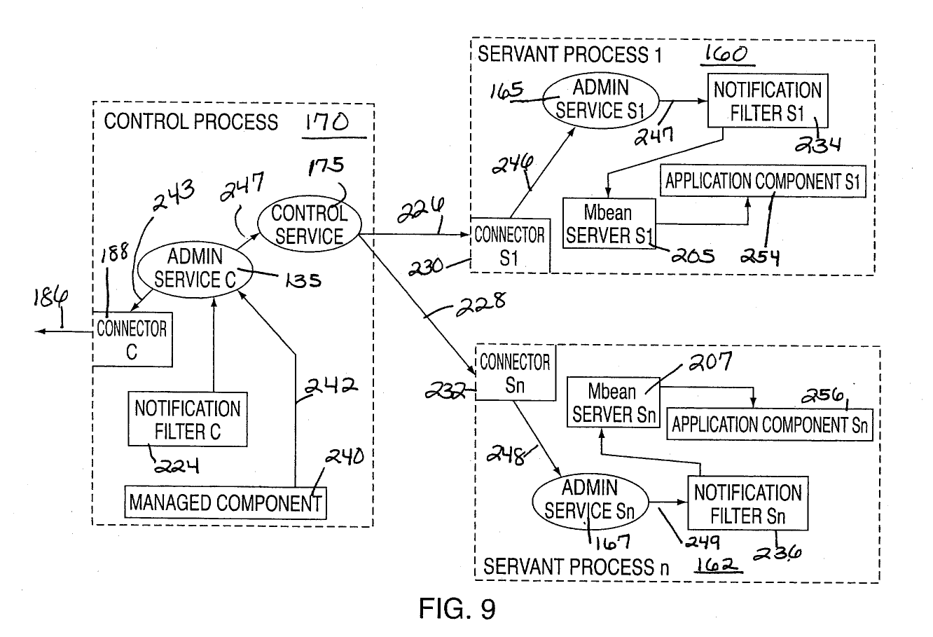

FIG. 9 depicts a notification sent from a Control MBean to all registered listeners. The notification originates in the Control Process 170 with a managed component 240 that sends the notification along path 242 to the local Admin Service 135. The local Admin Service 135 consults the local Notification Filter 224 to determine whether there are registered listeners for this notification type. Finding both remote and servant listeners, the Admin Service 135 initiates delivery along paths 247 of the notification to both listener types. The notification passes through the Control Process connector 188 to be delivered via path 186 to the remote listener. The Control Service 175 passes the notification along paths 226 and 228 to the servant processes 160 and 162 by way of their respective connectors 230 and 232. The connectors, in turn, pass the notification along paths 246 and 248 to the local Admin Services 165 and 167. From there, the notification along paths 247 and 249 flows through the Notification Filters 234 and 236 there to MBean Servers 205 and 207, and then is finally delivered to the registered listeners Application Components 254 and 256.

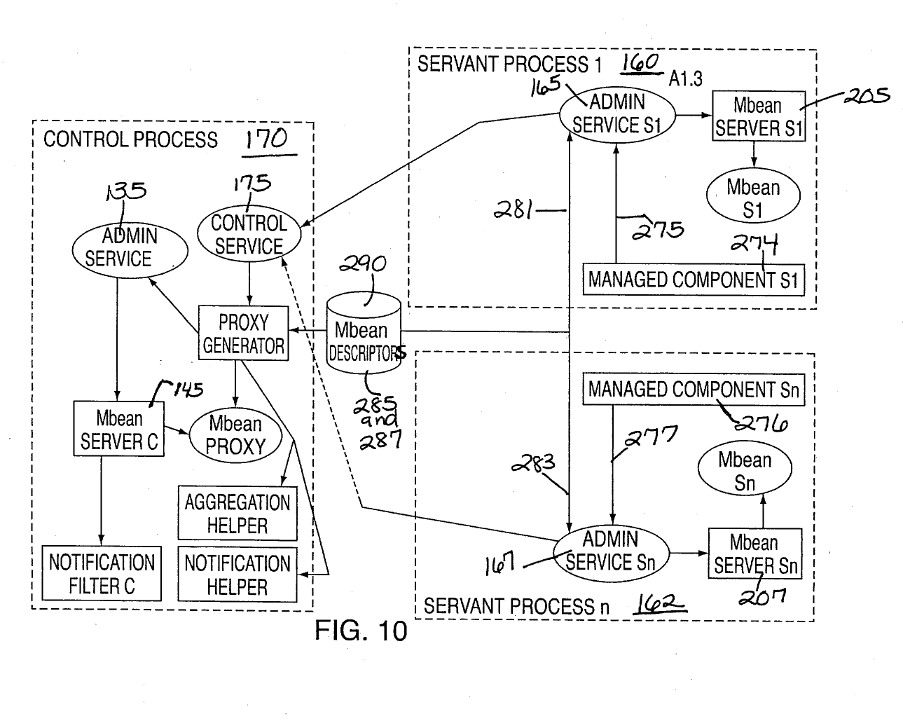

FIG. 10 depicts Servant Process MBean activation. Since the Servant Processes are homogeneously configured, different instances of the same managed component will activate the same logical MBean in each Servant Process. A dynamic proxying mechanism or arrangement is utilized in the Control Process 170 to dynamically construct and register a proxy that corresponds to the logical MBean being registered. Servant invocation, which follows the MBean invocations, will start with the MBean's proxy. The activation, then, starts with each managed component 274 and 276 calling via paths 275 and 277 their respective local Admin Services 165 and 167. Each Admin Service will read the MBean's descriptor 285 and 287 in registry 290 via paths 281 and 283 and register the MBean with its respective local MBean Server 205 or 207. The MBean descriptors include additional XML tags that designate the MBean is proxied and additional annotations that designate the proxy invocation pattern for each MBean operation. In the systems and methods of the present invention, the following patterns are needed and typically used in this environment:

1. simple—proxy forwards request to a single, arbitrary servant process

2. spray—proxy forwards request to all arbitrary servant processes

3. spray & aggregate—proxy forwards request to all arbitrary servant processes and the return value from each MBean invoked must be aggregated into a single return value to be returned to the MBean operation invoker.

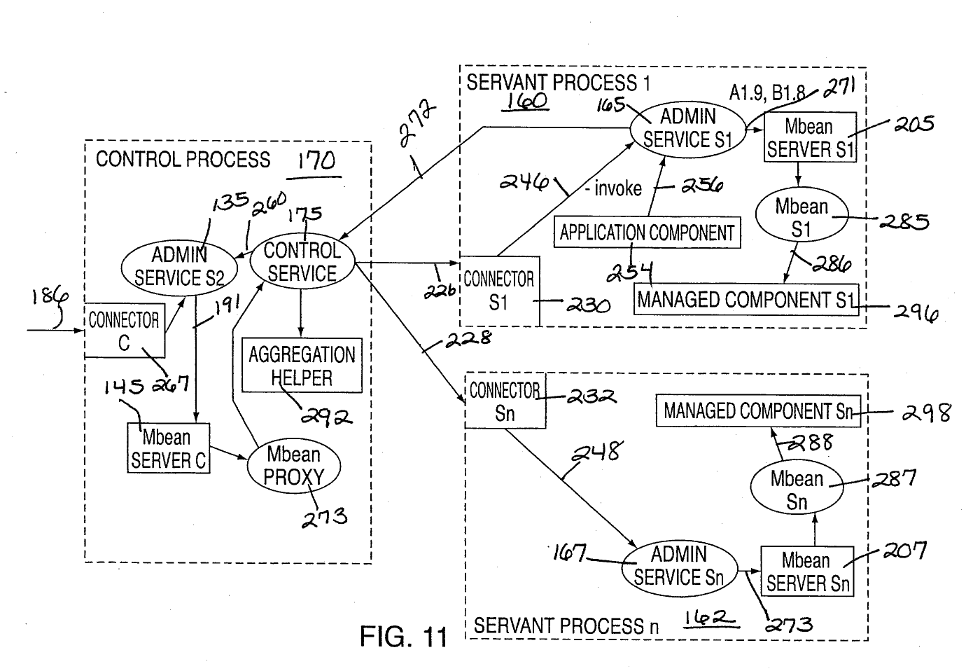

FIG. 11 depicts the flow of a servant MBean invocation. An application component 254 in Servant Process 160 and a remote caller from outside the server, both initiate an MBean operation invocation on a managed component. Starting with the Application Component's invocation on path 256 of the MBean operation, flow of control passes from the Application Component to the local Admin Service 165. The Admin Service forwards the request represented by path 272 to the Control Service 175. The Control Service, in turn, passes the request to the Control Process' Admin Service 135. Comparatively, the remote caller's invocation of the MBean operation would arrive on path 186 through the Control Process connector 267. In turn, the connector 267 would pass the request to the local Admin Service 135.

Starting from the Control Process' Admin Service 135, the flow of control is the same for both the Servant Process originated request (from the Application Component in Servant Process 1) and the remote caller originated request. From the Control Process Admin Service 135, the request flows along path 191 to the local MBean Server 145, which routes the request to the MBean proxy 273. The MBean proxy passes the request to the Control Service 175, which then distributes the request on paths 226 and 228 to each Servant Process. The request arrives at each Servant Process through that Servant Process' connector 230 and 232. The connectors, in turn, pass the requests along paths 246 and 248 on to their local Admin Services 165 and 167. From the local Admin Services they flow to the MBean Servers 205 and 207. From the MBean servers they flow to the MBean instances 285 and 287 and from there, they are at finally the managed component instances 296 and 298 are invoked. The managed component instances carry out the requested operation and optionally return a result value.

Assuming a result value, flow of control rewinds along the path it came until it reaches the Control Service 175 in the Control Process 170. The Control Service receives the return value passed back from each managed component instance. Once the return values from all managed component instances (one per Servant Process) have been received, the Control Service invokes the Aggregation Helper class 292 that was defined for this operation in the Managed Component's MBean Descriptor. The Aggregation Helper's job is to combine the multiple return value instances from the managed component's instances into a single, aggregate response to represent the return value from a single logical managed component. From the Aggregation Helper, flow of control rewinds all the way back to the original MBean operation which invokes the Application Component 254 in Servant Process 160 and a remote caller from outside the server.

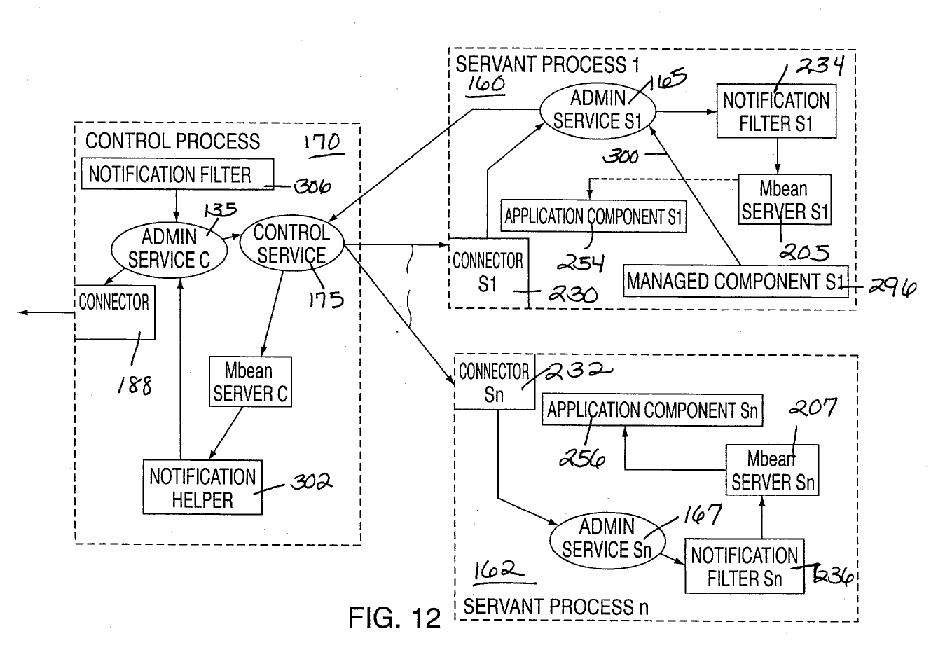

FIG. 12 depicts the flow of an event notification from a managed component to registered event listeners. Application Component instances 254 and 256 are registered event listeners. Implied, is a remote listener. Managed Component 296 in Servant Process 160 sends a notification along path 300. The notification is received by the local Admin Service 165, which in turn passes the notification to the Control Service 175 in the Control Process 170. The Control Service 175 passes the request to the MBean's Notification Helper 302 for this event, which was specified in the MBean's descriptor. The Notification Helper determines the action to take on the received event appropriately, such as waiting to combine it with other event instances it anticipates from other Managed Component instances or whether to forward the event immediately. For the sake of example, consider it simply forwarded immediately. The Notification Helper 302 then sends the event notification to the local Admin Service 135. The Admin Service references the local Notification Filter 306 to determine the destinations for this event. The Admin Service 135 then sends the notification to the Control Service 175 and the local connector 188, respectively. The connector 188 sends the notification to the remote listener. The Control Service 175 sends the notification to each of the servant processes 160, as there is a registered listener in each servant process. The notification is received in each servant process by that servant processes connector 230 and 232 in FIG. 12. The connectors pass the notification to their local Admin Services 165 and 167, respectively. For each servant process ‘p’ that has received the notification, it flows to the Notification Filter 235 to MBean Server 205, and to the registered notification listener Application Component Sp.

One aspect of the novelty of this invention is that JMX operations on a managed component are arranged to exhibit uniform behavior whether the server architecture in which the managed component executes is a single process, single JVM server or whether the server is a multi-process server with multiple JVMs, one per process. In the multi-process model, the managed component is treated as a logical component, comprised of a set of managed component instances, one per servant process. The communication and control structure of the exemplary embodiments allows MBean operations to flow across the multiple instances in such a way as to produce a result that is consistent with that of a managed component in a single process model which would have only a single instance. One important aspect of the present invention, then, is that it provides server process model transparency for the JMX.

The present invention has been described with respect to an implementation on a IBM z900 series multi-processor computer system running under the IBM's z/OS operating system and IBM's WebSphere application server management software package. Yet, those in the art should appreciate that the systems and method of the present invention may be utilized within the other known or suitable computer environments.

The systems and methods of the present invention need not be further described here since those skilled in the art, based on the teachings of the present invention, will readily understand how to implement the same. This in part is due to the widespread use of conventional automatic data recovery software and management tools in large computer systems in order to provide for a more graceful recovery from server failures and other sources of partial or total abnormal terminations. Any suitable programming approaches and/or other well-known protocols and tools familiar to those writing operating system and management system programs and/or components, including those used in object-oriented distributed computing environments, may be used to help code the software required to implement the nested recovery scope management systems and methods of the present invention. For example, the systems and processes of the present invention may be written as programs or a set of interrelated routines in any suitable programming language, such as but not limited to an object-oriented language and then deployed to run under the control of any suitable management software package including an operating system if desired.

The present invention has been described in part by reference to block and flow diagrams and elements of components, systems and steps of methods. As is well known, suitable program instructions provided in software are used to turn general purpose computers and/or processors into programmed computers and/or processors to form systems capable of carrying out the teachings of the present invention.

It should be appreciated by those skilled in the art that if desired, the systems, methods and software described herein may be implemented in part in firmware (including microcode) or hardware. Accordingly, the present invention may take the form of an embodiment including hardware and/or firmware, or an embodiment that is a combination of software, hardware and/or firmware. Further, the methods of the present invention may be carried out entirely in software, or in a combination of the software, hardware and/or firmware.

Also, the software employed to implement the present invention may be provided in any suitable form of computer program code embodied in tangible media, such as but not limited to floppy diskettes, CD-ROMs, hard drives, or any other computer readable storage medium. When such the computer program code, containing the needed instructions, is loaded into and is ready for execution by suitable computers/processors, such programmed computers/processors become an apparatus for practicing the invention. Thus, it should be appreciated that another embodiment of the present invention is the computer program code needed for carrying out the processes of the present invention when it is embodied in a tangible medium.

The foregoing detailed description shows that the exemplary embodiments of the present invention are well suited to fulfill the purposes above-stated. It is recognized that those skilled in the art may make various modifications or additions to the embodiments chosen to illustrate the present invention without departing from the spirit and proper scope of the invention. Accordingly, it is to be understood that the protection sought and to be afforded hereby should be deemed to extend to the subject matter defined by the appended claims, including all fair equivalents thereof.

What is claimed is:

1. In a multiple process computer system for use in distributed computing environments, the system being arranged to implement multiple instances of a Java Virtual Machine (JVM), a method for allowing the computer system to interact with both multiple process and single process JVMs external to the system, the method comprising the steps of:
providing a plurality of JVM servers on the multiple process computer system;
designating a first one of the JVM servers as a control JVM;
designating any other JVM server on the computer system as a servant JVM;
arranging to have each servant JVM operate under the control of the control JVM; and
arranging the computer system to present itself as a single-process JVM server to Java clients external to the computer system.

2. A multiple process computer system for use in distributed computing environments, the system being arranged to implement multiple instances of a Java Virtual Machine (JVM) and to interact with both multiple process and single process JVMs external to the system, the system comprising:
at least one multiple process computer system having at least one processor;
a plurality of JVM servers installed upon the computer system, wherein a first one of the JVM servers is arranged to operate as a control JVM, and wherein any other JVM server on the system is arranged to operate as a servant JVM under the control of the control JVM; and
wherein the computer system is arranged to present itself as a single-process JVM server to Java clients external to the computer system.

3. A computer program product, to be used in a distributed computing environment including at least one network with a plurality of computers and multiple Java clients and at least one multiple process Java server located thereon, and at least some Java clients external to the one multiple process Java server, the software product comprising:
a storage medium readable by at least one processing circuit and storing instructions for execution by the processing circuit for performing a method comprising the steps of—
providing a plurality of JVM servers on the multiple process computer system;
designating a first one of the JVM servers as a control JVM;
designating any other JVM server on the computer system as a servant JVM;
arranging to have each servant JVM operate under the control of the control JVM; and
arranging the computer system to present itself as a single-process JVM server to Java clients external to the computer system.
